(19) United States
(12) Patent Application Publication
(10) Pub. No.: US 2003/0107774 A1
(43) Pub. Date: Jun. 12, 2003

(54) Display device and method of providing same

(76) Inventor: Jeremy Graham Scott, London (GB)

Correspondence Address: CENTRAL COAST PATENT AGENCY, PO BOX 187, AROMAS, CA, 95004, US

(21) Appl. No.: 10/243,400

(22) Filed: Sep. 12, 2002

(30) Foreign Application Priority Data
Dec. 9, 2001 (GB) 0122054.0

(51) Int. Cl. H04N 1/21; H04N 1/23

(52) U.S. Cl. 358/302

(57) ABSTRACT

The invention relates to a display device which comprises a printed replication of a plurality of, in the embodiment, ceramic floor tiles. The array is digitally replicated using a digital camera to provide a visual image which is a printed, four colour, replica of the floor tiles. The replica, in A5 size on a foldable substrate such as paper, can be folded to A4 and taken by a prospective purchaser to a point of intended use, such as a home, where the visual effect of the tiles can be seen without the need to take an actual tile to the point of use.

### CROSS-REFERENCE TO RELATED DOCUMENTS

The present invention claims priority to a United Kingdom patent application number 0122054.0. The disclosure of said application is included herewith by reference.

The invention relates to a display device, and method of providing same.

Items such as floor, wall or ceiling tiles are often bought by a home buyer, or specified by an architect, particularly when an existing building is being refurbished. However, tiles, particularly ceramic tiles, are heavy, and often are bought “blind” in the sense that the purchaser cannot see them in situ in the location where they are ultimately to be placed. Stated in another way, buying tiles is a frustrating, laborious, time-consuming and inconvenient process for consumers. They must visit one or more retailers, where they are given, or have to pay a refundable deposit for, one or more single tile samples, or a heavy, wood-mounted set of a single design of tiles. They must then return it/them to the shop within a short period of time. Once back at home, individual tiles are too small and tile boards are too heavy and difficult to hold in position, to envisage the final design.

It is an object of this invention to seek to mitigate these disadvantages.

According to a first aspect of the invention there is provided a display device, comprising a printed representation of a plurality of assembled units, assembled as desired and printed to provide a visual image substantially identical to that of the assembled units whereby the representation replicates the units when placed in situ.

According to a second aspect of the invention, there is provided a method of providing a display device, comprising providing a plurality of units, assembling them in a desired array, photographing the assembled array, providing a colour image, adjusting the balance to provide a faithful reproduction of the array, and providing a proof.

According to a third aspect of the present invention, there is provided a method of providing a display device, comprising providing a plurality of digital images each of a unit, assembling the images of units into a desired array using a computer, and providing a printed representation of the array.

Using the invention it is possible to reproduce for example a ceramic tile in the form of a poster, which essentially enables a prospective customer to view different tile designs, in colour, conveniently, quickly and inexpensively, prior to purchase.

Embodiments of the invention are hereinafter described, by way of example, with reference to the accompanying drawings, which show schematically a display device and methods of producing same.

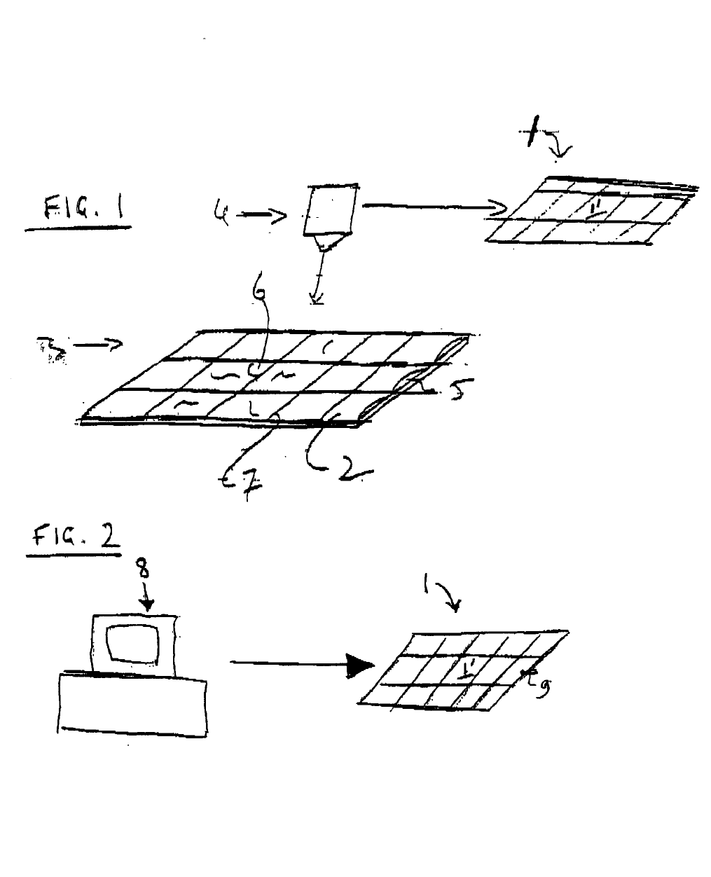

Referring to FIG. 1, the display device in the embodiment comprises a printed representation 1 of a plurality of assembled units such as ceramic floor tiles 2, which are assembled as an array 3 as desired, and printed to provide the display device 1 in the form of a visual image 1′, substantially identical to that of the assembled tiles whereby the representation replicates the tiles 2 when placed in situ. It will be understood that by providing a replication of the tiles they are reproduced substantially exactly in colour, shape and size.

The tiles 2 are selected and laid out in the desired array or pattern. The array is photographed using a digital camera 4, the image being digitally colour corrected and enhanced to provide a high resolution digital photograph. The correction and enhancement comprises digital retouching and colour balancing, as necessary.

The production of the image will usually be carried out in a studio or similar location, the tiles 2 having been provided in the desired array by a manufacturer or seller of tiles. That person will approve a wet proof, before the image is printed on one side only using a four colour process to provide an A1 display device 1 on a foldable substrate such as paper, which device 1 is effectively a poster showing the tiles 2. The poster is folded to A4 size and put up in a point-of-sale pack such as a transparent bag, the poster having identifiers such as bar codes and product details applied to it, say during the printing process. The bag is able to be hung up for display by having suspense means such as an affixed display hooks.

The reverse of the image of the display device 1 may have means to position it as desired, such as a release adhesive.

When a person wishes to buy tiles, he or she goes to a tile shop, and looks at the selection available, either by looking at the actual tiles, or posters thereof as embodied in the invention. Having decided on a particular range or ranges, the customer simply purchases as many of the relevant posters showing the respective tiles as desired, takes them to the point of intended use, such as home, and positions them on a desired surface such as the floor, wall or ceiling, to decide which is the preferred tile or tiles, for example from the design and colour as shown by the posters. Thus there are no heavy tile boards to carry home, which would then have to be returned to the shop, and no deposit to pay. Moreover, there is no guesswork needed in trying to decide what will be the overall effect, from looking at a single tile. Having decided from the poster 1 in situ the customer can then purchase the actual tiles chosen, confident of their visual effect when installed. The purchase may be from a wholesale or retail outlet, or from a relevant website.

It will be understood that the image may include borders 5 and/or units 6 and grout 7 of any desired texture and colour can be added as desired digitally during the photographic process.

Referring to FIG. 2, the display device 1 is produced by providing a plurality of digital images each of a unit such as a ceramic floor tile. The images are stored on a computer system 8. A user can select a plurality of images of tiles using the computer system and arrange them as desired to form a virtual array which is then printed to produce an A1 sized colour poster.

The image of each tile is obtained by digitally photographing individual tiles, the images being retouched and colour balanced as necessary to provide a faithful colour reproduction of the tiles.

The computer system 8 conveniently allows a user to select and arrange any combination of tiles to form the virtual array, either at the same location as the computer system in the shop or remotely over the internet. The chosen array is then printed to an A1 poster.

It will be understood that although tiles have been referred to, the invention as described herein with reference to the drawings can be used to replicate bricks or brick surfaces, for example a usual clay and sand brick, a glass brick, or a brick of any other suitable material. Moreover in every embodiment, replication of the actual product provides for making a copy of that product, or reproducing it, in its actual size including grouting so that the consumer can easily see this visual effect on array of such tiles would have when installed.

I claim:

1. A display device comprising:
(i) a printed representation of a plurality of assembled units;
(ii) said units being assembled as desired;
(iii) said units being printed to provide a visual image substantially identical to that of the assembled units whereby the representation replicates the units when placed in situ.

2. A device as defined in claim 1, wherein the units comprise tiles and wherein the representation comprises a digital photographic image thereof.

3. A device as defined in claim 2, wherein the image comprises a digitally colour corrected and enhanced image.

4. A display device as defined in claim 1, wherein the units comprise tiles and wherein the representation comprises a computer generated image using a plurality of digital photographs thereof.

5. A device as defined in claim 4, wherein the image is printed by a four colour process.

6. A device as defined in claim 1, wherein the image comprises border tiles.

7. A device as defined in claim 1, wherein the image includes a representation of grout between tiles.

8. A device as defined in claim 1, wherein the image includes a representation of grout between the tiles, included digitally.

9. A device as defined in claim 2, wherein the representation comprises A1 size folded to A4 size.

10. A device as defined in claim 1, wherein there is means to secure the device on a surface for display.

11. A device as defined in claim 10, wherein the means comprises releasable adhesive means.

12. A method of providing a display device, comprising:
(i) providing a plurality of units;
(ii) assembling said units in a desired array;
(iii) photographing said assembled array;
(iv) providing a colour image of said array;
(v) adjusting the balance to provide a faithful reproduction of the array; and
(vi) providing a proof.

13. A method as defined in claim 12, wherein the step of photographing comprises a digital photographic step and the step of adjusting the image comprises digitally retouching and colour balancing, whereby a faithful colour image is obtained.

14. A method as defined in claim 13, wherein the image is printed by a printing step.

15. A method as defined in claim 13, wherein the image is printed by a printing step which comprises a four colour printing step.

16. A method as defined in claim 13, wherein the step of providing a plurality of units comprises providing an array of tiles, assembled in a desired pattern prior to the photographic step, and wherein grout is added digitally to the image.

17. A method as defined in claim 13, wherein there is the step of providing border tiles in the array as desired, prior to the photographic step.

18. A method as defined in claim 13, wherein there is the step of providing a proof of A1 size, folding it to A4 size, and putting it up for sale in a point-of-sale pack.

19. A method of providing a display device, comprising:
(i) providing a plurality of digital images each of a unit;
(ii) assembling the images of units into a desired array using a computer, and
(iii) providing a printed representation of the array.

20. A method as defined in claim 19, wherein the step of providing the digital images comprises photographing each of the units, and the steps of digitally retouching and colour balancing, whereby a faithful colour image of each unit is obtained.

21. A method as defined in claim 19, wherein the representation is printed using a four colour process.

22. A method as defined in claim 19, wherein there is the step of digitally adding by computer a representation of grout between the images of units in the array.
